(19) United States
(12) Patent Application Publication
(10) Pub. No.: US 2019/0112131 A1
(43) Pub. Date: Apr. 18, 2019

(54) Article Transport Facility

(71) Applicant: Daifuku Co., Ltd., Osaka-shi (JP)

(72) Inventor: Yoshihiro Hosaka, Komaki-shi (JP)

(21) Appl. No.: 16/156,151

(22) Filed: Oct. 10, 2018

(30) Foreign Application Priority Data
Oct. 12, 2017 (JP) 2017-198771

(51) Int. Cl. B65G 35/06

(52) U.S. Cl. CPC B65G 35/06; B65G 2207/22

(57) ABSTRACT

An article transport facility comprises an article transport vehicle, a guide rail, and a fire door configured to open and close an opening formed in a wall. The fire door is rotatable with respect to the wall. The guide rail has a movable rail portion supported by the fire door, and two stationary rail portions arranged across the movable rail portion from each other. A movable guide portion is provided at one of an end portion of the movable rail portion and an end portion of the stationary rail portion. The movable guide portion is capable of being moved between a guiding position in which the movable guide portion connects the movable rail portion and the stationary rail portion with the fire door in an open position, and a retracted position for allowing unhindered movement of the fire door and the movable rail portion when the fire door is rotated.

### CROSS-REFERENCE TO RELATED APPLICATION

This application claims priority to Japanese Patent Application No. 2017-198771 filed Oct. 12, 2017, the disclosure of which is hereby incorporated in its entirety by reference.

### FIELD OF THE INVENTION

The present invention relates to an article transport facility comprising an article transport vehicle configured to travel along a travel path that extends through an opening formed in a wall, one or more guide rails configured to guide the article transport vehicle along the travel path, and a fire door configured to open and close the opening.

### BACKGROUND

As an example of such an article transport facility, the JP Publication of Utility Model No. H02-3751 (Patent Document 1) discloses a technology for avoiding interference between a fire door for closing a passage in an emergency and a guide rail that forms a travel path for article transport vehicles. The technology disclosed in this Patent Document 1 requires a movable portion which is provided in a portion of the guide rail and any interference between the fire door and the guide rail is avoided by moving the movable portion out of the way in an emergency.

However, with the technology of Patent Document 1 described above, in addition to a first actuator for moving the fire door, it is necessary to provide a second actuator for moving the movable portion of the guide rail. This makes the structure of the article transport facility become complex, which may lead to an increased manufacturing cost.

### SUMMARY OF THE INVENTION

Therefore, an article transport facility is desired in which it is possible to avoid any interference between a fire door and a guide rail with a relatively simple structure.

In light of above, an article transport facility comprises: an article transport vehicle configured to travel along a travel path that extends through an opening formed in a wall; a guide rail configured to guide the article transport vehicle along the travel path; a fire door configured to open and close the opening; wherein the fire door is rotatable with respect to the wall and is capable of being moved to an open position for leaving the opening open and to a closed position for closing the opening, wherein the guide rail has a movable rail portion supported by the fire door such that the movable rail portion is spaced apart from the fire door, and two stationary rail portions arranged across the movable rail portion from each other in a path longitudinal direction, which is a direction in which the travel path extends, such that the positions of the two stationary rail portions relative to the wall are fixed, wherein a movable guide portion is provided at a selected rail end portion which is one of an end portion of the movable rail portion and an end portion of the stationary rail portion which are across from each other, and wherein the movable guide portion is capable of being moved between a guiding position in which the movable guide portion connects the movable rail portion and corresponding one of the two stationary rail portions with the fire door in the open position, and a retracted position for allowing unhindered movement of the fire door and the movable rail portion when the fire door is rotated.

With such an arrangement, since the fire door and the movable rail portion can be moved together, the movable rail portion is rotated as the fire door is rotated. Therefore, it is not necessary to provide an additional mechanism for retracting a part of the guide rail for preventing it from contacting fire door when the fire door is moved from the open position to the closed position. Therefore, interference between the fire door and the guide rail can be avoided with a relatively simple structure. In addition, when fire door is in the open position, the movable guide portion in the guiding position connects the movable rail portion and the stationary rail portion. When the fire door is rotated, the movable guide portion is moved to the retracted position, allowing the fire door and the movable rail to be rotated, thus allowing their unhindered movement. Therefore, an arrangement can be provided that allows the fire door to be properly rotated when, for example, a fire breaks out and that also reduces vibrations or a jolt that may occur when an article transport vehicle travels through a relatively large gap between a movable rail portion and a stationary rail portion.

### BRIEF DESCRIPTION OF THE DRAWINGS

FIG. 1 is a plan view of an article transport vehicle,

FIG. 2 is a side view of the article transport vehicle,

FIG. 3 is a front view of the article transport vehicle,

FIG. 4 is a side view showing a principal portion of an article transport facility in accordance with the first embodiment, with the fire door in an open position,

FIG. 5 is a side view showing a principal portion of an article transport facility in accordance with the first embodiment, with the fire door in a closed position,

FIG. 6 is a front view of the fire door in the open position and related portions,

FIG. 7 is a plan or top-down view of the fire door in the open position and related portions,

FIG. 8 is a front view of the fire door in the closed position and related portions,

FIG. 9 is a side view showing a principal portion of an article transport facility in accordance with the second embodiment, with a fire door in the open position, and

FIG. 10 is a side view showing a principal portion of an article transport facility in accordance with the second embodiment, with the fire door in the closed position.

### DETAILED DESCRIPTION

### 1. First Embodiment

The first embodiment of an article transport facility is described next with reference to the attached drawings.

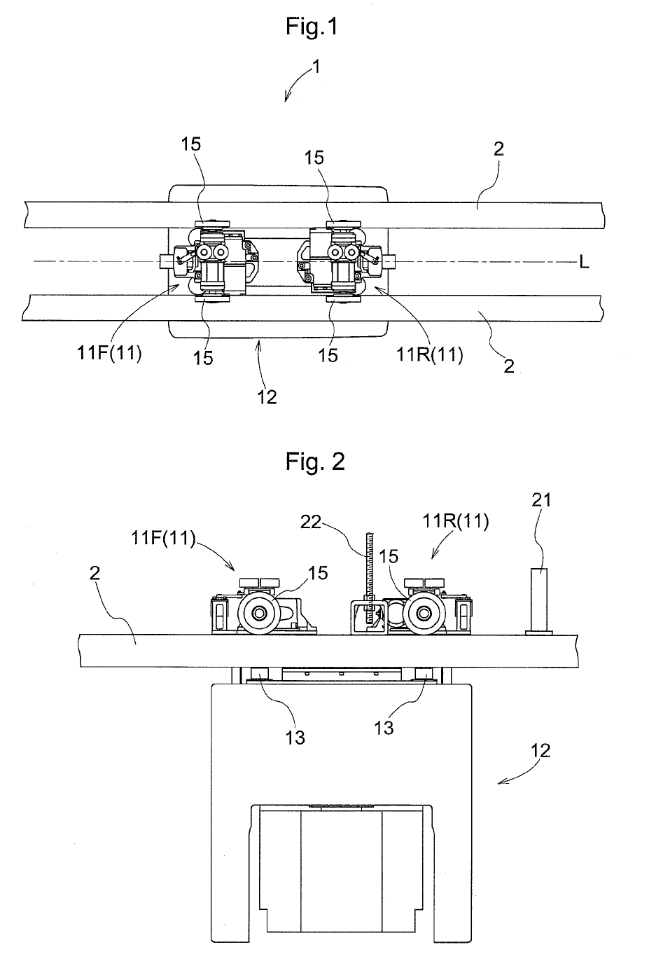

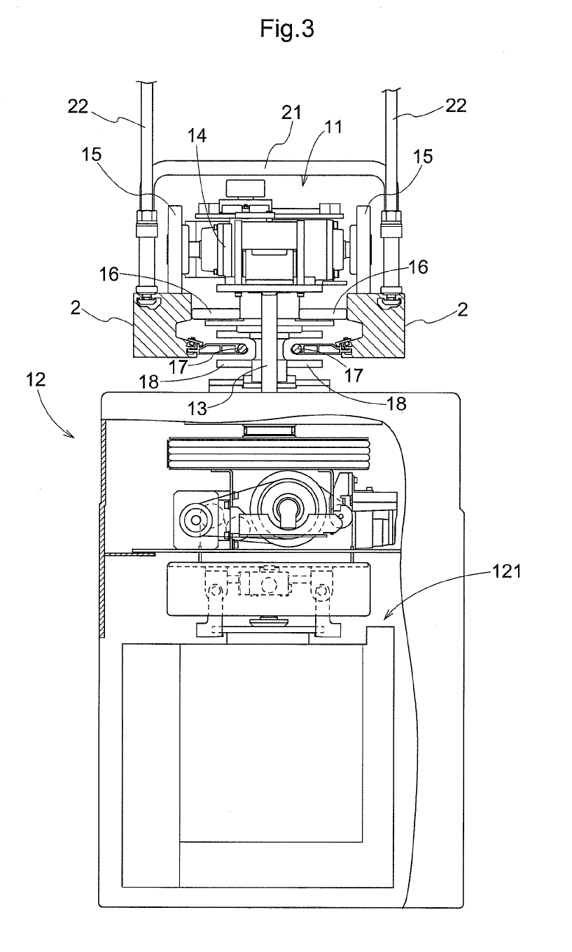

As shown in FIGS. 1 through 3, an article transport facility in accordance with the first embodiment includes one or more article transport vehicles 1 each configured to travel along a travel path L to transport an article, and guide rails 2 configured to guide the article transport vehicles 1 along the travel path L.

Note that, in the following description, a direction parallel to the travel path L will be referred to as the “path longitudinal direction”. The path longitudinal direction coincides with the front-and-back direction of the article transport vehicle 1. The right and left directions (as well as the right and left direction) of the article transport facility is defined as such as seen from the back toward the front of an article transport vehicle 1 when the article transport vehicle is located in a straight portion of the travel path L immediately before the entering the opening 3a described below. In addition, the “vertical direction” coincides with the vertical direction of an article transport facility.

In addition, in the following description, the expression “along” used in conjunction with a certain direction is a concept that includes not only a direction parallel to that certain direction but also a direction that is slightly tilted (for example, by an angle of less than 10 degrees) from that certain direction and should be interpreted as such. In addition, terms and expressions describing a direction, or a dimension, etc. (e.g., “parallel”, “equally spaced”, etc.) in the following description are concepts that allow for variations (permissible variations in manufacturing, installing or assembling process) and should be interpreted as such.

Each article transport vehicle 1 has travel portions 11 configured to travel on the pair of right and left guide rails 2, a vehicle main body 12 which is located lower than the guide rails 2 and suspended and supported by the travel portions 11, and connecting portions 13 connecting the vehicle main body 12 to the travel portions 11. The vehicle main body 12 includes a support portion 121 configured to support an article being transported with the article being suspended therefrom. In addition, in the present embodiment, each article being transported is a FOUP (Front Opening Unified Pod) for holding one or more semiconductor wafers.

The travel portions 11 include a front travel portion 11F and a back travel portion 11R which are spaced apart from each other in a direction parallel to the front-and-back direction.

The vehicle main body 12 is rotatably connected to each of the front and back connecting portions 13 for rotation about vertical axes of the front and back connecting portions 13. Each of the front travel portion 11F and the back travel portion 11R is capable of rotating with the connecting portion 13 to which the travel portion 11F or 11R is connected about the vertical axis of that connecting portion 13. The pair of front and back connecting portions 13 is located between the pair of right and left guide rails 2.

The front travel portion 11F is provided with a pair of right and left travel wheels 15 which are drivingly rotated by an electric-powered actuating motor 14 and which are arranged to roll on travel surfaces formed by respective top surfaces of the pair of right and left guide rails 2. In addition, the front travel portion 11F includes a pair of right and left guide wheels 16 which are rotatable about respective axes each extending along the vertical direction (i.e., about respective vertical axes) with each of the right and left guide wheels 16 in contact with corresponding one of inward surfaces of the pair of right and left guide rails 2. Note that the front travel portion 11F is provided with two such pairs of right and left guide wheels 16 with one pair spaced apart from the other in a direction parallel to the front-and-back direction.

In addition, the back travel portion 11R is similarly provided with one pair of right and left travel wheels 15 and two pairs of right and left guide wheels 16, as with the front travel portion 11F.

Thus, each article transport vehicle 1 is provided with pairs of right and left travel wheels 15. Each of the pair of right and left guide rails 2 has a travel surface on which the travel wheels 15 of the article transport vehicle 1 roll.

Power-receiving portions 18 to which driving electric power is supplied from electricity supply lines 17 each installed along corresponding one of the pair of right and left guide rails 2 are provided on and above the top surface of the vehicle main body 12. These power-receiving portions 18 are located between the pair of front and back connecting portions 13 and between the pair of right and left guide rails 2.

Each article transport vehicle 1 is configured to travel along the guide rails 2 as a result of the travel wheels 15 of the front travel portion 11F and the back travel portion 11R being drivingly rotated, while the position of the article transport vehicle 1 in the right and left direction, or the lateral direction, is restricted as a result of the guide wheels 16 of the front travel portion 11F and the back travel portion 11R being guided by the pair of right and left guide rails 2.

The pair of right and left guide rails 2 are connected to each other by rail connecting members 21 each formed in a shape of an inverted letter “U” as seen in the path longitudinal direction, and are a type of rails that are suspended from the ceiling of a building by means of first rail support members 22.

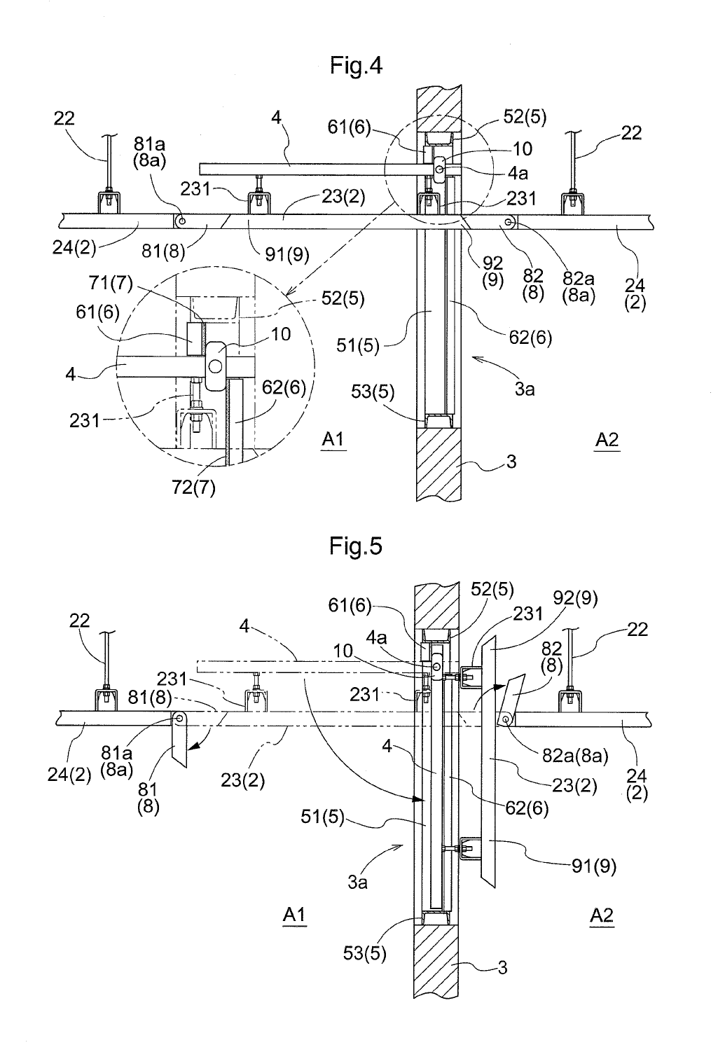

As shown in FIG. 4, the article transport facility arranged as described above is installed to lie in, and extend between, a first area A1 and a second area A2. Each of the first area A1 and the second area A2 is a clean room. Provided at the boundary between the first area A1 and the second area A2 are a wall 3 which functions as a partition between the first area A1 and the second area A2 and in which an opening 3a for the travel path L of the article transport vehicle 1 is formed, and a fire door 4 configured to open and close the opening 3a. The opening 3a which is described to be formed in the wall 3 means an opening 3a that, when not closed, allows an article transport vehicle 1 to travel from one side of the wall 3 to the other side of the wall 3. In the present embodiment, the wall 3 extends along the vertical direction and the right and left direction.

The arrangement and structure of the fire door as well as those of the portions and parts related to, or associated with, the fire door 4, of the article transport facility, are described next.

As shown in FIGS. 4 and 5, the fire door 4 is provided to the wall 3 such that the fire door 4 can be rotated, or is rotatable, with respect to the wall 3 and is configured to be moved to an “open position” for leaving the opening 3a open and a “closed position” for closing the opening 3a. In the present embodiment, the fire door 4 generally has a plate-shape that has a certain thickness (dimension parallel to the path longitudinal direction when in the closed position) and that extends along the right and left direction and a direction perpendicular to the right and left direction, with the plate-shape being a shape which is flat and whose thickness is less than its dimensions parallel to the two directions referred to above. The open position is a position in which a surface of the generally plate-shape fire door 4 extends along a direction parallel to the horizontal plane whereas the closed position is a position in which the surface extends along the vertical direction. In addition, in the present embodiment, the fire door 4 is rotatable about a door pivot shaft 4a. The door pivot shaft 4a extends along a direction parallel to the horizontal plane and along a direction that crosses (and is more preferably perpendicular to) the path longitudinal direction. In the present embodiment, the door pivot shaft 4a is located in the opening 3a, is near the upper end of the opening 3a, and extends along the right and left direction.

In the present embodiment, the center of gravity of the fire door 4 is at a location spaced apart from the door pivot shaft 4a. The center of gravity of the fire door 4 in the open position is located higher than the center of gravity of the fire door 4 in the closed position. Thus, the fire door 4 can be moved (rotated) from the open position to the closed position by gravity under its own weight. The fire door 4 is held in the open position under normal conditions by a lock mechanism (not shown) which may include a pin, a lever, and/or a latch, which can be operated and moved. In an emergency such as when a fire breaks out, the fire door 4 is released from the lock mechanism, allowing the fire door 4 to be rotated from the open position to the closed position by gravity under its own weight. In the present embodiment, the fire door 4 is supported by a frame 5 fixed to the wall 3 through the door pivot shaft 4a.

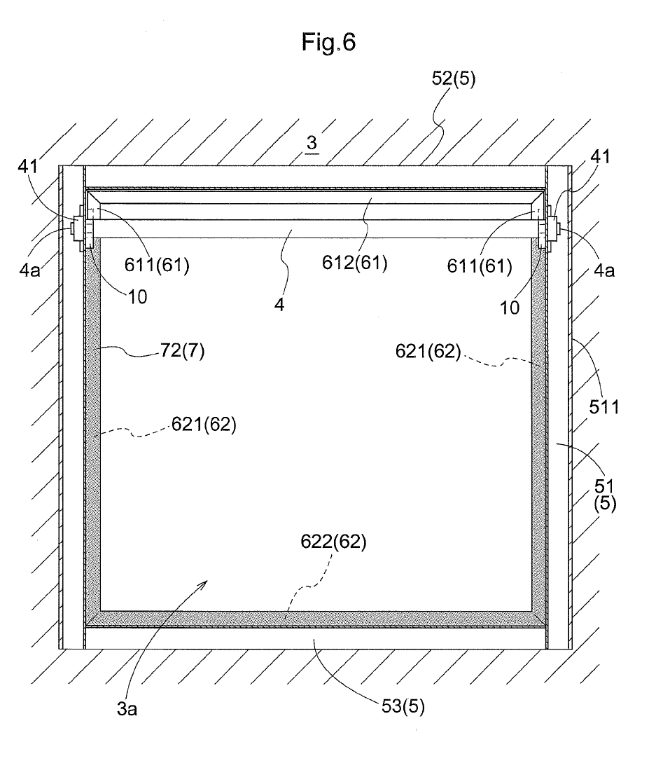

As shown in FIG. 6, the frame 5 extends parallel to the outer edge of the opening 3a, and is fixed to the inward surface of the wall 3 which is oriented toward the opening 3a. In the present embodiment, since the opening 3a is formed to be rectangular in shape as seen in the path longitudinal direction, the frame 5 is formed to be rectangular in shape as seen in the direction parallel to the path longitudinal direction. The frame 5 has a pair of vertical frame portions 51, an upper frame portion 52, and a lower frame portion 53.

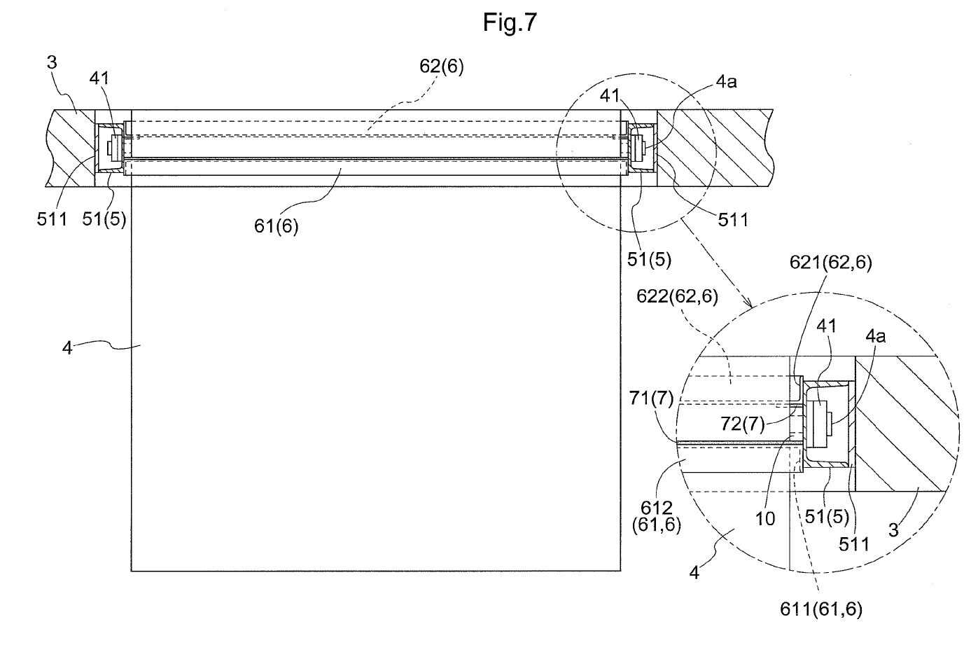

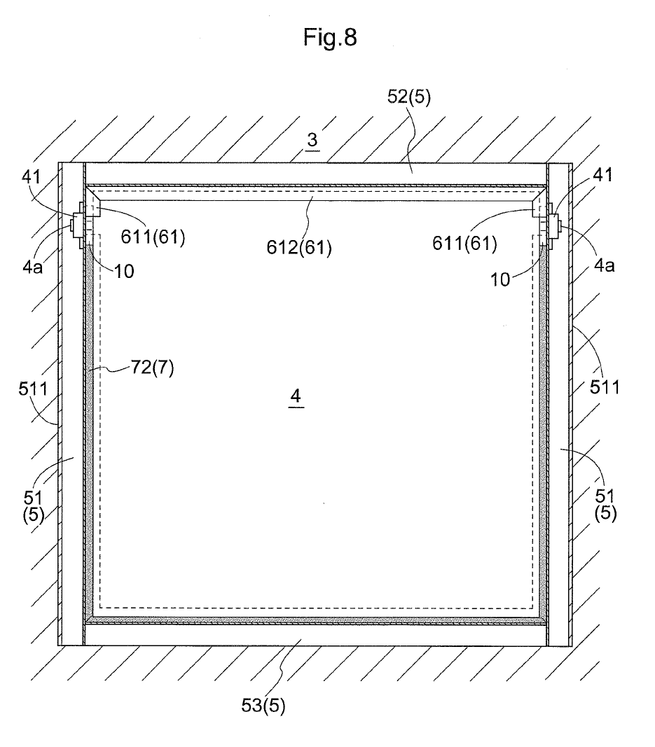

Note that, in FIG. 6 as well as in FIGS. 7 and 8, the guide rails 2, among other things, are not shown in the interest of convenience in describing the things that are shown.

As shown in FIGS. 6 and 7, the pair of vertical frame portions 51 extend along the vertical direction and are spaced apart from each other by a set distance in the right and left direction. Each of the pair of vertical frame portions 51 is generally formed in a shape of the letter “U” with right-angle corners (or bracket shape) that face outward and away from each other in directions parallel to the right and left direction. In other words, the vertical frame portions 51 are arranged to have a right and left symmetry so that the left-hand side vertical frame portion 51 is generally formed in a shape of the letter “U” with right-angle corners (or a bracket shape) that faces toward left whereas the right-hand side vertical frame portion 51 is generally formed in a shape of the letter “U” with right-angle corners (or a bracket shape) that opens toward right. The opening of each vertical frame portion 51 is covered by a cover member 511 which is fixed to the wall 3 and which is plate-shaped (generally flat and thin (thickness less than length and width)). A shaft support member 41 which rotatably supports the corresponding door pivot shaft 4a is fixed to the inward face portion of each vertical frame portion 51 (portion that is opposite the opening or the portion next to the fire door 4). While not shown, a through hole extending in a direction parallel to the right and left direction for inserting a door pivot shaft 4a is formed in the inward face portion of each vertical frame portion 51.

The upper frame portion 52 extends along the right and left direction and between the pair of vertical frame portions 51, and is fixed to the upper ends of the vertical frame portions 51. The upper frame portion 52 is generally formed in a shape of the letter “U” with right-angle corners (or a bracket shape) that opens upward (see FIG. 4). The upper frame portion 52 is fixed to the wall 3 such that its opening is covered by a portion of the wall 3. The lower frame portion 53 extends along the right and left direction and between the pair of vertical frame portions 51, and is fixed to the lower ends of the vertical frame portions 51. The lower frame portion 53 is generally formed in a shape of the letter “U” with right-angle corners (or a bracket shape) that opens downward (see FIG. 4). The lower frame portion 53 is fixed to the wall 3 such that its opening is covered by a portion of the wall 3.

A contact member 6 is fixed to the frame 5 in the present embodiment. The contact member 6 is formed to extend along the outer edge of the opening 3a. In the present embodiment, the contact member 6 is generally arranged in a shape of a rectangular frame as seen in a direction parallel to the path longitudinal direction, and is fixed to the inward surface of the frame 5. The contact member 6 includes an upper contact portion 61 and a lower contact portion 62.

As shown in FIGS. 4, 5, 6, and 8, the upper contact portion 61 and the lower contact portion 62 are spaced apart from each other in a direction parallel to the vertical direction. The upper contact portion 61 is located higher than the door pivot shaft 4a. The lower contact portion 62 is located lower than the door pivot shaft 4a. In addition, as shown in FIGS. 4, 5, and 7, the upper contact portion 61 and the lower contact portion 62 are also spaced apart from each other in the path longitudinal direction. In other words, the upper contact portion 61 and the lower contact portion 62 are so located that the fire door 4 in the closed position is located between them in the direction parallel to the path longitudinal direction (see FIG. 5).

As shown in FIGS. 6 and 8, the upper contact portion 61 has a pair of upper vertically extending portions 611 and an upper horizontally extending portion 612. The upper vertically extending portions 611 of the pair extend along the vertical direction, and are spaced apart from each other in a direction parallel to the right and left direction. Each upper vertically extending portion 611 of the pair is generally formed in a shape of the letter “L” in plan or top-down view (see FIG. 7). Each of the upper vertically extending portions 611 of the pair is fixed to a sub-portion (of the corresponding vertical frame portion 51) that is located lower than the upper frame portion 52 and higher than the fire door 4 in the open position (see FIG. 6). The upper horizontally extending portion 612 extends along the right and left direction and between the pair of upper vertically extending portions 611, and is fixed to the upper ends of the upper vertically extending portions 611. The upper horizontally extending portion 612 is also fixed to the upper frame portion 52 of the frame 5. The upper horizontally extending portion 612 is generally formed in a shape of the letter “L” in a side view.

The lower contact portion 62 has a pair of lower vertically extending portions 621 and a lower horizontally extending portion 622. The lower vertically extending portions 621 of the pair extend along the vertical direction, and are spaced apart from each other in a direction parallel to the right and left direction. Each lower vertically extending portion 621 of the pair is generally formed in a shape of the letter “L” in plan or top-down view (see FIG. 7). Each of the lower vertically extending portions 621 of the pair is fixed to a sub-portion (of the corresponding vertical frame portion 51) that is located higher than the lower frame portion 53 and lower than the fire door 4 in the open position (see FIG. 6). The lower horizontally extending portion 622 extends along the right and left direction and between the pair of lower vertically extending portions 621, and is fixed to the lower ends of the lower vertically extending portions 621. The lower horizontally extending portion 622 is also fixed to the lower frame portion 53 of the frame 5. The lower horizontally extending portion 622 is generally formed in a shape of the letter “L” in a side view.

As shown in FIG. 8, the upper contact portion 61 overlaps with an outer edge of a portion (of the fire door 4 in the closed position) that is located higher than the door pivot shaft 4a, as seen in the path longitudinal direction (i.e., parallel to a normal direction to the paper). Thus, when the fire door 4 is in the closed position, the upper contact portion 61 is in contact with a portion of one (first) flat surface of the fire door 4 (flat surface that becomes the top surface of the fire door 4 when in the open position) that is located higher than the door pivot shaft 4a. On the other hand, the lower contact portion 62 overlaps with an outer edge of a portion (of the fire door 4 in the closed position) that is located lower than the door pivot shaft 4a, as seen in the path longitudinal direction. Thus, when the fire door 4 is in the closed position, the lower contact portion 62 is in contact with a portion of the other (second) flat surface of the fire door 4 (flat surface which becomes the bottom surface of the fire door 4 when in the open position) that is located lower than the door pivot shaft 4a.

Here, the concept of “overlapping” includes a partial overlap. When it is stated (as a way of describing relative locations of two things) that two things “overlap” as seen in a specified direction, it means that, when an imaginary line parallel to the specified direction is moved in a direction perpendicular to the imaginary line, there is an area in which this imaginary line intersects both of the two things at the same time.

Because the contact member 6 is arranged as described above, the contact member 6 does not prevent or hinder the movement (rotation) of the fire door 4 from the open position to the closed position under its own weight in spite of the fact that the contact member 6 is so located to surround the fire door 4 along the outer edge of the fire door 4.

In addition, in the present embodiment, a sealing member 7 is provided to the contact member 6. The sealing member 7 is attached to the contact member 6 so as to be located between the fire door 4 and the contact member 6 when the fire door 4 is in the closed position. It is preferable to use resilient material with high heat resistance, such as silicone, for the sealing member 7.

As shown in FIGS. 4 and 5, the sealing member 7 includes an upper sealing portion 71 and a lower sealing portion 72. The upper sealing portion 71 is attached to a surface of the upper contact portion 61 that is in contact with the fire door 4 when the fire door 4 is in the closed position. The lower sealing portion 72 is attached to a surface of the lower contact portion 62 that is in contact with the fire door 4 when the fire door 4 is in the closed position. It is preferable that the sealing member 7 extends along the outer edge of the opening 3a. In the present embodiment, the upper sealing portion 71 is provided to cover the entire surface of the upper contact portion 61 that comes into contact with the fire door 4 whereas the lower sealing portion 72 is provided to cover the entire surface of the lower contact portion 62 that comes into contact with the fire door 4. The sealing member 7 helps in properly closing the opening 3a to improve the fire door's ability to prevent passage of smoke and heat.

As shown in FIGS. 4 and 5, each guide rail 2 has a movable rail portion 23 supported by the fire door 4 such that the guide rail 2 is spaced apart from the fire door 4, and two stationary rail portions 24 arranged across the movable rail portion 23 from each other in the path longitudinal direction, such that the positions of the two stationary rail portions 24 are fixed relative to the wall 3.

In addition, since the pair of right and left guide rails 2 has a right and left symmetry, a description is given below with respect to only one of the two guide rails 2, with a description for the other omitted.

In the present embodiment, the movable rail portion 23 is supported by the fire door 4 through a plurality of second rail support members 231. In other words, the movable rail portion 23 is not supported by the ceiling through the first rail support members 22. Thus, as the fire door 4 is rotated, the movable rail portion 23 is rotated with its distance to the fire door 4 kept constant. The dimensions of the movable rail portion 23 and the distance between the fire door 4 and the movable rail portion 23 are set such that the movable rail portion 23 can be moved through the opening 3a when the fire door 4 is rotated from the open position to the closed position. Note that the distance between the fire door 4 and the movable rail portion 23 can be changed by adjusting the lengths of the second rail support members 231. In the present embodiment, the movable rail portion 23 is so located to be parallel to the fire door 4. Thus, as shown in FIG. 4, when the fire door 4 is in the open position, the movable rail portion 23 is suspended from the fire door 4 and is in an attitude in which it extends along the path longitudinal direction. In addition, as shown in FIG. 5, when the fire door 4 is in the closed position, the movable rail portion 23 is in an attitude in which it extends along the vertical direction.

The two stationary rail portions 24 are so located to be spaced apart from each other in the path longitudinal direction, and aligned with each other with respect to the vertical direction as well as to the right and left direction. The distance between the two stationary rail portions 24 is set such that neither of the stationary rail portions 24 comes into contact with the fire door 4 and the movable rail portion 23 when the fire door 4 is rotated. Each of the two stationary rail portions 24 is supported by the ceiling through the first rail support members 22. When the fire door 4 is in the open position, the two stationary rail portions 24 and the movable rail portion 23 form a travel path L for the article transport vehicle 1. In the present embodiment, a movable guide portion 8 is provided at the end portion of each of the two stationary rail portions 24 which is located across from the movable rail portion 23 when the fire door 4 is in the open position. Note that the movable guide portions 8 may be provided at the end portions of the movable rail portion 23 as with the second embodiment described below. Thus, in the description below, one of (i) an end portion of the movable rail portion 23 and (ii) an end portion of a stationary rail portion 24 which are across from each other, at which a movable guide portion 8 is provided will be referred to as a “selected rail end portion” whereas the other of (i) an end portion of the movable rail portion 23 and (ii) an end portion of a stationary rail portion 24 which are across from each other, at which movable guide portion 8 is not provided will be referred to as a “non-selected rail end portion”.

Each movable guide portion 8 is configured to be moved between a guiding position in which the movable guide portion 8 connects the movable rail portion 23 and the stationary rail portion 24 with the fire door 4 in the open position, and a retracted position for allowing unhindered movement of the fire door 4 and the movable rail portion 23 when the fire door 4 is rotated. In the present embodiment, each movable guide portion 8 is configured to be rotatable about a guide portion pivot shaft 8a extending parallel to a direction along which the door pivot shaft 4a extends, and with respect to a selected rail end portion (end portion of the corresponding stationary rail portion 24). Each movable guide portion 8 is in the guiding position when the fire door 4 is in the open position. Thus, when the fire door 4 is in the open position, each movable guide portion 8 connects the movable rail portion 23 and a stationary rail portion 24, making it possible for an article transport vehicle 1 to travel through the movable rail portion 23 and the stationary rail portions 24. On the other hand, when the fire door 4 is rotated, each movable guide portion 8 is moved to its retracted position. Thus, neither of the movable guide portions 8 comes into contact with the fire door 4 or the movable rail portion 23 when the fire door 4 is rotated.

In the present embodiment, a rest portion 9 is provided at each end portion of the movable rail portion 23 which are non-selected rail end portions. Each rest portion 9 is configured such that an end portion of the corresponding movable guide portion 8 rests, or is placed, on it when the movable guide portion 8 is in the guiding position. In the present embodiment, each rest portion 9 has a surface that is tilted upward or is tilted to be closer to the movable guide portion 8 (that it faces) toward the lower edge of the surface. In addition, an end portion of each movable guide portion 8 is formed to have a tilted surface that is parallel to the tilted surface of the corresponding rest portion 9. As shown in FIG. 4, this arrangement allows the end portion of each movable guide portion 8, to rest, or is placed, on the corresponding rest portion 9 when the movable guide portions 8 are in the guiding position. As such, each movable guide portion 8 is held in its guiding position by the corresponding rest portion 9 when the fire door 4 is in the open position. Note that, the shapes or any other arrangements of the end portions of the rest portions 9 and the movable guide portions 8 are not limited to those described above, and instead may be of any shapes and other arrangements as long as the end portion of each movable guide portion 8 rests, or is placed on, the corresponding rest portion 9 when the movable guide portion 8 is in the guiding position.

Note that, in the following description, the rest portion 9 that is farther from the wall 3 will be referred to as the first rest portion 91 whereas the rest portion 9 that is closer to the wall 3 will be referred to as the second rest portion 92. In addition, the movable guide portion 8 that faces the first rest portion 91 will be referred to as the first movable guide portion 81 whereas the movable guide portion 8 that faces the second rest portion 92 will be referred to as the second movable guide portion 82. Further, the guide portion pivot shaft 8a of the first movable guide portion 81 will be referred to as the first guide portion pivot shaft 81a whereas the guide portion pivot shaft 8a of the second movable guide portion 82 will be referred to as the second guide portion pivot shaft 82a.

In the present embodiment, when the fire door 4 is rotated, the movable rail portion 23 is rotated such that the first rest portion 91 is moved downward and the second rest portion 92 is moved upward. As the movable rail portion 23 is so moved, the first movable guide portion 81 which has been resting, or placed, on the first rest portion 91 is rotated under its own weight about the first guide portion pivot shaft 81a to its retracted position such that an end of the first movable guide portion 81 is moved downward. On the other hand, the second movable guide portion 82 which has been resting, or placed, on the second rest portion 92 is rotated about the second guide portion pivot shaft 82a to its retracted position as a result of being pushed upward by the second rest portion 92 such that an end of the second movable guide portion 82 is moved upward. Thus, when the fire door 4 is rotated from its open position to its closed position, the first movable guide portion 81 and the second movable guide portion 82 do not come into contact with the fire door 4 and the movable rail portion 23. In addition, in order to assist the upward movement of the end of the second movable guide portion 82, an urging member (not shown), such as a coil spring, arranged and configured to provide an upward urging force, that is less than the weight of the second movable guide portion 82, to the end of the second movable guide portion 82 may be provided.

In the present embodiment, a pair of secondary sealing members 10 configured to close a gap in an area where a contact member 6 cannot be provided because presence of such a contact member would otherwise hinder the rotation of the fire door 4. As shown in FIGS. 4 through 7, each secondary sealing member 10 is located in an overlapped portion between (i) an area from the upper contact portion 61 to the lower contact portion 62 in the path longitudinal direction and (ii) an area from the upper contact portion 61 to the lower contact portion 62 in the vertical direction. Each secondary sealing member 10 is configured to close a gap in a direction parallel to the door pivot shaft 4a between a side surface of the fire door 4 and an inward surface of the opening 3a (an inward surface of the frame 5 in the present example).

In the present embodiment, each secondary sealing member 10 is attached to the door pivot shaft 4a to be located between a side surface of the fire door 4, and a vertical frame portion 51 of the frame 5. In the present embodiment, the dimension of each secondary sealing member 10 in the path longitudinal direction is set to be equal to the distance between the upper contact portion 61 and the lower contact portion 62 in the path longitudinal direction (see FIG. 4), as seen in the vertical direction. As shown in FIG. 6, the vertical dimension of each secondary sealing member 10 is set to be slightly greater than the vertical distance between the upper contact portion 61 the lower contact portion 62 as seen along the path longitudinal direction such that an upper portion and a lower portion of the secondary sealing member 10 overlap with the upper contact portion 61 and the lower contact portion 62 respectively as seen along the path longitudinal direction. In addition, as shown in FIG. 7, the thickness (the dimension in the right-and-left direction) of the secondary sealing member 10 is set to be equal to the distance between a side surface of the fire door 4 and an inward surface of the vertical frame portion 51 (surface of the vertical frame portion 51 that faces in a direction opposite from the direction that portion of the vertical frame portion 51 opens, i.e., a surface that is oriented toward the fire door 4). Note that a minimum requirement for each secondary sealing member 10 is to close a gap in an area of overlap between (i) an interval between the upper contact portion 61 to the lower contact portion 62 in the path longitudinal direction (i.e., interval in the path longitudinal direction between an imaginary vertical plane that includes the surface of the upper contact portion 61 to which the upper sealing portion 71 is attached and an imaginary vertical plane that includes the surface of the lower contact portion 62 to which the lower sealing portion 72 is attached) and (ii) an interval between the upper contact portion 61 and the lower contact portion 62 in the vertical direction (i.e., interval in the vertical direction between an imaginary horizontal plane that includes the bottom surface of the upper contact portion 61 and an imaginary plane that includes the top surface of the lower contact portion 62). For example, each secondary sealing member 10 may extend from the bottom surface of the upper frame portion 52 to the top surface of the lower frame portion 53 as seen in the path longitudinal direction.

### 2. Second Embodiment

The second embodiment of an article transport facility is described next with reference to the attached drawings. In the present embodiment, the selected rail end portions and the non-selected rail end portions differ from those in the first embodiment described above. More specifically, in the present embodiment, end portions of each movable rail portion 23 are selected rail end portions, and the end portion of each stationary rail portion 24 is a non-selected rail end portion. In other words, a movable guide portion 8 is provided at each end portion of each movable rail portion 23. The description below is provided with respect to one of the two guide rails 2 because of the right and left symmetry of the pair, with a focus on the differences between the first embodiment described above and the second embodiment. Note that any features and arrangements that are not specifically described below should be understood to be identical to those in the first embodiment.

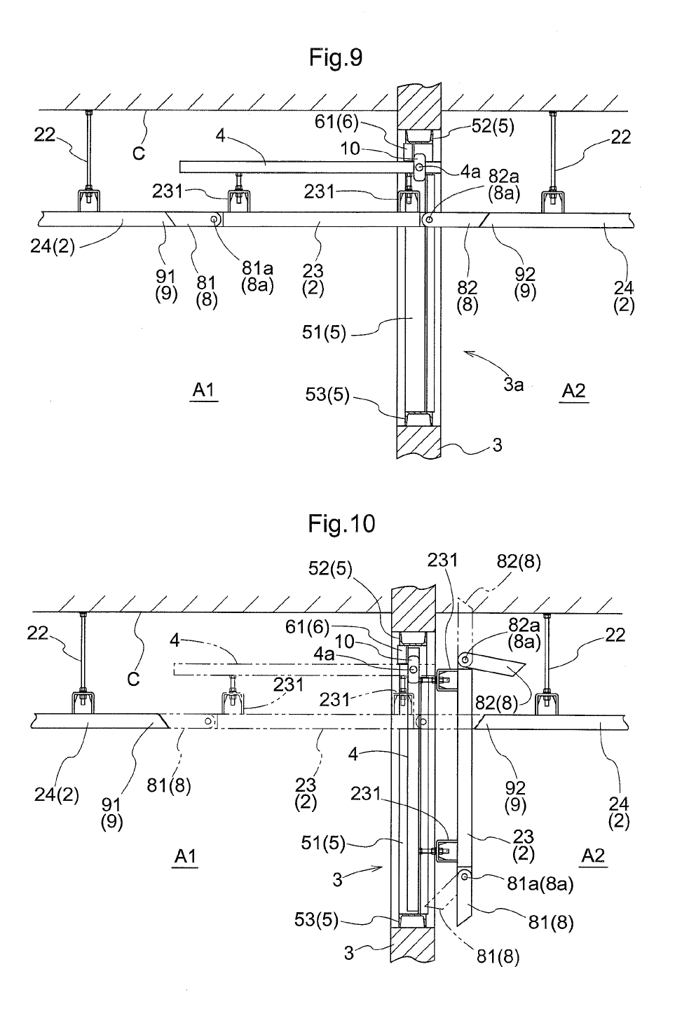

As shown in FIGS. 9 and 10, in the present embodiment, a movable guide portion 8 is provided at each of the end portions of the movable rail portion 23, each of which end portions is thus a selected rail end portion. A rest portion 9 is provided at the end portion of each of the two stationary rail portions 24, which end portion is thus a non-selected rail end portion.

In the present embodiment, when the fire door 4 is rotated, the movable rail portion 23 is rotated such that the first movable guide portion 81 is moved downward and the second movable guide portion 82 is moved upward. When this happens, the positional relationship between the first movable guide portion 81 and the first rest portion 91 is such that they are in contact with each other; however, this does not affect the rotation of the movable rail portion 23 because the first movable guide portion 81 is rotated while it is supported by the first rest portion 91 when the movable rail portion 23 is rotated. After the first movable guide portion 81 is moved past the positions at which it is in contact with the first rest portion 91, the first movable guide portion 81 simply dangles under its own weight.

On the other hand, although the second movable guide portion 82 does not interfere with the stationary rail portion 24, its positional relationship with the ceiling C is such as to cause it to come into contact with the ceiling C as the fire door 4 is moved to the closed position. However, in the present embodiment, the second movable guide portion 82 is rotated about its guide portion pivot shaft 8a such that the end portion of the second movable guide portion 82 is moved downward (clockwise in FIG. 10) because of its own inertia when the fire door 4 is rotated; and so, the second movable guide portion 82 is rotated into its retracted position. This causes the second movable guide portion 82 to become so oriented that it does not come into contact with the ceiling C. Note that it may be so arranged that the movable guide portion 8 is moved to its retracted position as a result of the movable guide portion 8 being rotated about its guide portion pivot shaft 8a such that the end of the movable guide portion 8 is moved upward. This may be accomplished, for example, by providing an urging member that constantly urges the end portion of the movable guide portion 8 upward, and by providing a mechanism that holds the movable guide portion 8 in its guiding position against the upward urging force by the urging member when the fire door 4 is in the open position and that releases the movable guide portion 8 when the fire door 4 is rotated.

Note that the distance between the fire door 4 and the movable rail portion 23 is set such that the first movable guide portion 81 and the second movable guide portion 82 come out of contact with the fire door 4 when the first movable guide portion 81 and the second movable guide portion 82 are moved from respective guiding positions to respective retracted positions.

### 3. Other Embodiments

(1) In the embodiments described above, examples are described in which a movable guide portion 8 is provided at the end portion of each of two stationary rail portions 24 of each guide rail 2 as described in the first embodiment and a movable guide portion 8 is provided at each of two end portions of the movable rail portion 24 of each guide rail 2 as described in the second embodiment. However, the invention is not limited to such arrangements. For example, the arrangement may be such that a movable guide portion 8 is provided at the end portion of the stationary rail portion 24 while another movable guide portion 8 is provided at an end portion of the movable rail portion 23 that is not located opposite the movable guide portion 8 provided to the stationary rail portion 24. Alternatively, the arrangement may be such that a movable guide portion 8 is provided only between one of the two stationary rail portions 24 and the movable rail portion 23 while providing no movable guide portion 8 between the other stationary rail portion 24 and the movable rail portion 23. In the second embodiment described above, if the ceiling C is located high above, for example, so that a portion that corresponds to the second movable guide portion 82 is so located that it would not come into contact with any member, then the second movable guide portion 82 would not have to be provided. In such a case, it would be preferable that the movable rail portion 23 is so formed to extend to a point that correspond to the end of the second movable guide portion 82 as shown in FIG. 9.

(2) In the embodiments described above, an example is described in which the fire door is provided to be rotatable about a door pivot shaft which extends along a direction parallel to the horizontal plane and along a direction that crosses the path longitudinal direction. However, the invention is not limited to such arrangement, the fire door may be provided to be rotatable about a door pivot shaft which extends along the vertical direction. In such a case, it would be preferable that an actuator configured to rotate the fire door from an open position to a closed position is provided.

(3) In the embodiments described above, an example is described in which each movable guide portion 8 is rotated about a guide portion pivot shaft 8a which extends along the direction in which the door pivot shaft 4a extends. However, the invention is not limited to such arrangement. For example, each movable guide portion 8 may be arranged to be rotated about a guide portion pivot shaft which extends along the vertical direction.

(4) In the embodiments described above, an example is described in which a rest portion 9 was provided at each non-selected rail end portion. However, the invention is not limited to such arrangement. The rest portion 9 does not have to be provided at a non-selected rail end portion if the corresponding movable guide portion 8 is capable of supporting the load on it from the article transport vehicle 1 as it travels over the movable guide portion 8.

(5) In the embodiments described above, an example is described in which the contact member 6 including the upper contact portion 61 and the lower contact portion 62 is provided. However, the invention is not limited to such arrangement. For example, only one of the upper contact portion 61 and the lower contact portion 62 may be provided. Alternatively, the arrangement may be such that no contact member 6 is provided.

(6) In the embodiments described above, an example is described in which the guide rails 2 are suspended from the ceiling of a building. However, the invention is not limited to such arrangement. One or more rails 2 may be installed on a floor surface as guide rail(s).

(7) Note that an arrangement disclosed in any of the embodiments described above can also be used in combination with any arrangement disclosed in any other embodiment unless inconsistency arises. Regarding any other arrangements and features, the embodiments disclosed in the present description are provided for the purposes of illustration only regarding all aspects. Therefore, it is possible to make various suitable changes without departing from the spirit of the present disclosure.

### 4. Brief Summary of Embodiments Described Above

A brief summary of the article transport facility described above is provided next.

An article transport facility comprises: an article transport vehicle configured to travel along a travel path that extends through an opening formed in a wall; a guide rail configured to guide the article transport vehicle along the travel path; a fire door configured to open and close the opening; wherein the fire door is rotatable with respect to the wall and is capable of being moved to an open position for leaving the opening open and to a closed position for closing the opening, wherein the guide rail has a movable rail portion supported by the fire door such that the movable rail portion is spaced apart from the fire door, and two stationary rail portions arranged across the movable rail portion from each other in a path longitudinal direction, which is a direction in which the travel path extends, such that the positions of the two stationary rail portions relative to the wall are fixed, wherein a movable guide portion is provided at a selected rail end portion which is one of an end portion of the movable rail portion and an end portion of the stationary rail portion which are across from each other, and wherein the movable guide portion is capable of being moved between a guiding position in which the movable guide portion connects the movable rail portion and corresponding one of the two stationary rail portions with the fire door in the open position, and a retracted position for allowing unhindered movement of the fire door and the movable rail portion when the fire door is rotated.

With such an arrangement, since the fire door and the movable rail portion can be moved together, the movable rail portion is rotated as the fire door is rotated. Therefore, it is not necessary to provide an additional mechanism for retracting a part of the guide rail for preventing it from contacting fire door when the fire door is moved from the open position to the closed position. Therefore, interference between the fire door and the guide rail can be avoided with a relatively simple structure. In addition, when fire door is in the open position, the movable guide portion in the guiding position connects the movable rail portion and the stationary rail portion. When the fire door is rotated, the movable guide portion is moved to the retracted position, allowing the fire door and the movable rail to be rotated, thus allowing their unhindered movement. Therefore, an arrangement can be provided that allows the fire door to be properly rotated when, for example, a fire breaks out and that also reduces vibrations or a jolt that may occur when an article transport vehicle travels through a relatively large gap between a movable rail portion and a stationary rail portion.

Here, a distance between the fire door and the movable rail portion is preferably set such that the movable guide portion comes out of contact with the fire door when the movable guide portion is moved from the guiding position to the retracted position.

With such an arrangement, it becomes possible to have a space for the movable guide portion to be moved in by utilizing a space between the fire door and the movable rail portion. Therefore, a movable guide portion which would not hinder the rotation of the fire door and the movable rail can be provided relatively easily.

In addition, the fire door is preferably rotatable about a door pivot shaft which extends along a horizontal plane and along a direction that crosses the path longitudinal direction, and wherein a center of gravity of the fire door is at a location spaced apart from the door pivot shaft, and the center of gravity of the fire door in the open position is located higher than the center of gravity of the fire door in the closed position.

With such an arrangement, the fire door can be moved from the open position to the closed position by gravity under its own weight. This makes it unnecessary to provide an additional source of actuating force for moving the fire door from the open position to the closed position. Therefore, the structure of the article transport facility can be simplified.

In addition, the movable guide portion is preferably rotatable with respect to the selected rail end portion about a guide portion pivot shaft which extends along a direction in which the door pivot shaft extends, wherein a rest portion is provided at a non-selected rail end portion which is one of said end portion of the movable rail portion and the end portion of the stationary rail portion which are across from each other, at which the movable guide portion is not provided, and wherein an end portion of the movable guide portion is so configured to rest on the rest portion when the movable guide portion is in the guiding position.

With such an arrangement, the end portion of the movable guide portion rests on and supported by the rest portion when the movable guide portion is in its guiding position. This makes it unnecessary to provide neither a source of actuating force nor an operable lock mechanism for keeping the movable guide portion in its guiding position when the fire door is in the open position. Therefore, the structure of the article transport facility can be further simplified.

The article transport facility preferably further comprises a contact member which is formed to extend along an outer edge of the opening, wherein the contact member includes an upper contact portion located higher than the door pivot shaft and a lower contact portion located lower than the door pivot shaft, wherein the upper contact portion and the lower contact portion are across the fire door from each other in the path longitudinal direction when the fire door is in the closed position, such that the upper contact portion is in contact with a first surface of the fire door and the lower contact portion is in contact with a second surface of the fire door that faces away from the first surface.

With such an arrangement, when the fire door is in the closed position, a portion of the first surface of the fire door that is located higher than the door pivot shaft is in contact with the upper contact portion while a portion of the second surface of the fire door that is located lower than the door pivot shaft is in contact with the lower contact portion. Thus, the fire door can stop with sufficient accuracy at its closed position while enabling the fire door to properly close the opening. In addition, the movement (rotation) of the fire door under its own weight from the open position to the closed position is not prevented by this contact member.

In addition, the article transport facility preferably further comprises a secondary sealing member, wherein the secondary sealing member is located in an overlapped portion between (i) an area from the upper contact portion to the lower contact portion in the path longitudinal direction and (ii) an area from the upper contact portion to the lower contact portion in the vertical direction, and closes a gap in a direction parallel to the door pivot shaft between a side surface of the fire door and an inward surface of the opening.

With such an arrangement, the secondary sealing member closes a gap in an area where a contact member cannot be provided because presence of such a contact member would otherwise hinder the rotation of the fire door. Such an arrangement helps in improving the fire door's ability to prevent passage of smoke and heat.

Also, the guide rail is preferably suspended from a ceiling of a building, wherein, when in the open position, the fire door is in an attitude in which the fire door extends along the ceiling, and wherein the movable rail portion is supported by the fire door such that the movable rail portion is suspended from the fire door when the fire door is in the open position.

With such an arrangement, when the guide rail is suspended from a ceiling, the fire door in its open position can be prevented from hindering the traveling of an article transport vehicle, it becomes possible for the fire door in the open position to suspend and support the movable rail in a proper position. Therefore, the structure of the article transport facility can be simplified.

### INDUSTRIAL APPLICABILITY

The present invention can be used in an article transport facility comprising an article transport vehicle configured to travel along a travel path that extends through an opening formed in a wall, one or more guide rails configured to guide the article transport vehicle along the travel path, and a fire door configured to open and close the opening.

What is claimed is:

1. An article transport facility comprising:
an article transport vehicle configured to travel along a travel path that extends through an opening formed in a wall;
a guide rail configured to guide the article transport vehicle along the travel path;
a fire door configured to open and close the opening;
wherein the fire door is rotatable with respect to the wall and is capable of being moved to an open position for leaving the opening open and to a closed position for closing the opening,
wherein the guide rail has a movable rail portion supported by the fire door such that the movable rail portion is spaced apart from the fire door, and two stationary rail portions arranged across the movable rail portion from each other in a path longitudinal direction, which is a direction in which the travel path extends, such that the positions of the two stationary rail portions relative to the wall are fixed,
wherein a movable guide portion is provided at a selected rail end portion which is one of an end portion of the movable rail portion and an end portion of the stationary rail portion which are across from each other, and
wherein the movable guide portion is capable of being moved between a guiding position in which the movable guide portion connects the movable rail portion and corresponding one of the two stationary rail portions with the fire door in the open position, and a retracted position for allowing unhindered movement of the fire door and the movable rail portion when the fire door is rotated.

2. The article transport facility as defined in claim 1, wherein a distance between the fire door and the movable rail portion is set such that the movable guide portion comes out of contact with the fire door when the movable guide portion is moved from the guiding position to the retracted position.

3. The article transport facility as defined in claim 1, wherein the fire door is rotatable about a door pivot shaft which extends along a horizontal plane and along a direction that crosses the path longitudinal direction, and
wherein a center of gravity of the fire door is at a location spaced apart from the door pivot shaft, and the center of gravity of the fire door in the open position is located higher than the center of gravity of the fire door in the closed position.

4. The article transport facility as defined in claim 3, wherein the movable guide portion is rotatable with respect to the selected rail end portion about a guide portion pivot shaft which extends along a direction in which the door pivot shaft extends,
wherein a rest portion is provided at a non-selected rail end portion which is one of said end portion of the movable rail portion and the end portion of the stationary rail portion which are across from each other, at which the movable guide portion is not provided, and
wherein an end portion of the movable guide portion is so configured to rest on the rest portion when the movable guide portion is in the guiding position.

5. The article transport facility as defined in claim 3, further comprising:
a contact member which is formed to extend along an outer edge of the opening,
wherein the contact member includes an upper contact portion located higher than the door pivot shaft and a lower contact portion located lower than the door pivot shaft, and
wherein the upper contact portion and the lower contact portion are across the fire door from each other in the path longitudinal direction when the fire door is in the closed position, such that the upper contact portion is in contact with a first surface of the fire door and the lower contact portion is in contact with a second surface of the fire door that faces away from the first surface.

6. The article transport facility as defined in claim 5, further comprising:
a secondary sealing member, and
wherein the secondary sealing member is located in an overlapped portion between (i) an area from the upper contact portion to the lower contact portion in the path longitudinal direction and (ii) an area from the upper contact portion to the lower contact portion in the vertical direction, and closes a gap in a direction parallel to the door pivot shaft between a side surface of the fire door and an inward surface of the opening.

7. The article transport facility as defined in claim 1, wherein the guide rail is suspended from a ceiling of a building,
wherein, when in the open position, the fire door is in an attitude in which the fire door extends along the ceiling, and
wherein the movable rail portion is supported by the fire door such that the movable rail portion is suspended from the fire door when the fire door is in the open position.
